(19) United States
(12) Patent Application Publication
(10) Pub. No.: US 2026/0243075 A1
(43) Pub. Date: Aug. 20, 2026

(54) WATER INLET SYSTEM IN A TOILET CISTERN

(71) Applicant: SIAMP CEDAP, Monaco (MC)

(72) Inventors: Stéphane MARNAS, NICE (FR); Olivier PLAS, LA TRINITE (FR)

(21) Appl. No.: 19/126,685

(22) PCT Filed: Oct. 25, 2023
(86) PCT No.: PCT/EP2023/079716

§ 371 Date: May 2, 2025

(30) Foreign Application Priority Data
Nov. 4, 2022 (FR) 22/11497

(51) Int. Cl. E03D 1/32

(52) U.S. Cl. CPC E03D 1/32

(57) ABSTRACT

The water feed system comprises: includes
a body provided with an air intake port;
a first pipe connected to a water supply network;
a second pipe in communication with the first pipe via an opening and including a lumen located vertically in line with the air intake port.

The system also includes a flap capable of shutting off the opening
a shutter movable between a low position, in which it rests on the lumen and a high position, in which it shuts off the air intake port;
and a flow modification device, downstream of the lumen, creating a back pressure.

The shutter has a density greater than 1.4, thus preventing it from floating. It is moved to its upper position by the back pressure.

### CROSS-REFERENCE TO RELATED APPLICATIONS

This application is a 35 U.S.C. § 371 National Stage patent application of PCT/EP2023/079716, filed on 25 Oct. 2023, which claims the benefit of French patent application 22/11497, filed on 4 Nov. 2022, the disclosures of which are incorporated herein by reference in their entirety.

### TECHNICAL FIELD

The disclosure relates to a system for feeding water into a flush tank.

### BACKGROUND

Conventionally, such a system comprises a pipe that is connected to a water supply network and which emerges into the tank. A valve allows or prevents the flow of water into the tank according to the height of water therein.

It is imperative to prevent water from flowing back into the supply network, which can typically occur in case of a negative pressure in the network. For this purpose, it is known to provide an air intake port at the upper part of the water feed systems.

In operation, when the valve opens, water flows into the pipe. In order to prevent water drops from escaping through the air intake port, water feed systems are typically provided with a movable shutter that is raised by flotation as soon as it is reached by the water level. The shutter therefore closes the air intake port very quickly, thus preventing splashing. In doing so, the air present in the system is trapped. This air mixes with the water, creating bubbles that generate an unpleasant noise.

### SUMMARY

The disclosure aims to remedy this drawback, that is to say to reduce or eliminate the cavitation noises following the opening of the valve.

To this end, and according to a first aspect, the disclosure relates to a system for feeding water into a flush tank, comprising, in the mounted position:
a body including in its upper part an air intake port;
a first pipe provided in the body, configured to be connected, at its upstream end, to a water supply network;
a second pipe provided at least partly in the body, having an upstream end in fluid communication with the first pipe via an opening, and a downstream end located lower than the upstream end, the second pipe including a lumen located substantially vertically in line with the air intake port, the peripheral edge of the lumen defining a bearing surface;
a valve which is mounted on the body and which, according to the height of water in the tank, can be in a closed state in which it shuts off said opening sealingly, or in an open state in which the opening is released;
a shutter movable between:
   a low position, in which it rests on the bearing surface, providing in the lumen a communication space between the inside and the outside of the second pipe, the air intake port being clear;
   and a high position, in which it shuts off the air intake port.

According to a general definition of the disclosure, the water feed system further comprises a flow modification device which is fastened to the second pipe downstream of the lumen and which creates a back pressure when water flows through the system towards the tank. In addition, the shutter has a density greater than 1.4, thus preventing it from floating. Thus, starting from an inactive state of the system where the flap is in the closed position and the shutter in the low position, the opening of the valve and the resulting flow of water into the second pipe causes the shutter to move to its high position under the effect of the back pressure created by the flow modification device.

With such an arrangement, for the shutter to be able to move to its high position, it is not sufficient for the water level to reach the shutter as is the case in the prior art where the shutter is designed to float. In the system according to the disclosure, since the shutter has a density preventing it from floating, an additional force must be exerted on the shutter to be able to lift it. This occurs when the back pressure created by the flow modification device, that is to say the pressure which opposes the flow of the fluid, is sufficient to lift the shutter. The movement of the shutter of the system of the disclosure to its high position therefore occurs with a time offset compared to a movement by simple flotation as is the case in the prior art. Therefore, this allows more time for the air in the body to escape through the air intake port before it is shut off. As a result, the amount of bubbles in the water flowing through the water feed system is significantly reduced, resulting in a significant decrease in the noise occurring when the valve is opened.

According to a possible embodiment, the shutter has a density greater than 2.

The shutter can be made of a material belonging to the group consisting of: stainless steel, glass, aluminum, polyoxymethylene (POM), filled plastic materials (for example with a mineral filler or with glass fibers or carbon fibers) such as filled polyamide in particular. More generally, the shutter can be made of any material that does not float and that is resistant to water over time.

According to one possible embodiment, the shutter is a ball.

In this case, the lumen provided in the second pipe may be oblong, or substantially oval, so as to leave a communication space between the inside and the outside of the second pipe when the ball is in the low position. This allows air to enter inside the second pipe, through the air intake port, when the ball is in the low position.

For example, the distance traveled by the shutter between the low position and the high position is greater than half the height of the shutter, preferably greater than the height of the shutter. This distance being relatively large, and greater than in the prior art, the movement of the shutter to its high position requires a certain time during which the air can be evacuated through the air intake port. Thus, this dimensional characteristic makes it possible to further improve the performance of the system according to the disclosure.

According to a possible embodiment, the shutter is located in a housing provided in the body, said housing having the shape of a bell converging upwards, and having a lower opening located in the vicinity of the lumen provided in the second pipe and an upper opening located in the vicinity of the air intake port or forming the latter. This housing, which can be mounted in a cylindrical portion of the body, makes it possible to guide the movement of the shutter towards its high position, and to channel the air.

According to one embodiment, the second pipe includes a first substantially horizontal portion in which the lumen is provided, extended by a second substantially vertical and descending portion. The lumen is preferably located in the vicinity of the junction between the first and second portions. With this arrangement, the shutter is directly subjected to the effect of the back pressure, since it is located substantially in alignment with the second substantially vertical portion of the second pipe.

According to one embodiment, the bearing surface defined by the lumen extends substantially in a plane which is inclined relative to a horizontal plane, downstream, at an angle in the range of 4 to 8°. In addition, the oblong—or substantially oval—lumen has a large dimension oriented generally parallel to the axis of the first portion of the second pipe (by means of the aforementioned inclination). In this way, in the low position, due to gravity, the shutter is located reproducibly at the downstream end of the lumen. the upstream part of the lumen is free, allowing more efficient evacuation of the air.

The water feed system may further comprise a cap which is mounted on the body above the air intake port, and which includes a channel having a hole located opposite the air intake port and emerging to the outside of the body, so that drops projected from the inside of the body via the air intake port can enter the channel and be guided therein until they fall back into the tank, in the mounted position of the system. The fact of delaying the shutting off of the air intake port compared to the prior art can result in the exit of drops through this port, which is not desirable, and the cap makes it possible to limit the projection of drops. With this arrangement, the disclosure makes it possible to reduce the noise generated while controlling splashing. Of course, the cap does not prevent the entry of air through the air intake port, the air being able to enter via the channel of the cap.

According to a second aspect, the disclosure relates to toilets including a bowl, a flush tank and a system for feeding water into the tank as previously described.

According to a first embodiment, the flow modification device comprises a tip fastened to the downstream end of the second pipe, the tip having a convergent section and being configured to form part of a device for sucking by Venturi effect. In this case, it is the restriction of the water passage section which creates the back pressure. With such an arrangement, the toilet may comprise a flush system which comprises:
a water feed system as described above;
a vertical ascending ejection tube mounted on the tip, the upstream end of the ejection tube being placed opposite the downstream end of the tip, at least one port being provided between the tip and the ejection tube to allow the suction of the water contained in the tank by Venturi effect;
a discharge tube mounted at the downstream end of the ejection tube, to direct the water towards the bowl.

The flush tank may be located at approximately the same height as the bowl, since the water feed implements the Venturi effect, which does not require gravity to operate. The toilet may further comprise a system for filling the flush tank that is separate from the flush system.

According to a second embodiment, the flow modification device comprises a sleeve mounted inside the second pipe, the sleeve containing a set of balls between which the water can flow, and forming a silencer allowing the decrease of the noise generated by the flow. In this case, it is the fact of forcing the water to pass between the balls which creates the back pressure. With such an arrangement, said water feed system forms a system for filling the flush tank.

### BRIEF DESCRIPTION OF THE DRAWINGS

Several possible embodiments of the disclosure are now described, by way of non-limiting examples, with reference to the appended figures:

FIG. 1 is a schematic view in vertical section in a plane P1 of a system for feeding water into a flush tank, according to the disclosure, said system including a flow modification device and a shutter, the latter being in the low position;

FIG. 2 is a partial perspective view, cut along a vertical plane P2 orthogonal to the plane P1, of the system of FIG. 1;

FIG. 3 is a partial perspective view, cut along the plane P1, of the system of FIG. 1;

FIG. 4 is a detailed view of the water feed system, in section in the plane P1, when the shutter is in the high position;

FIG. 5 is a detail view, in section in the plane P2, when the shutter is in the high position;

FIG. 6 is a perspective view of a flush system which includes a water feed system according to a first embodiment;

FIG. 7 is a perspective view of a toilet including the flush system of FIG. 6; FIG. 8 is a detail view, in vertical section, of the flush system of FIG. 6, showing the flow modification device;

FIG. 9 is a cross-sectional view of a water feed system according to a second embodiment, this system forming a system for filling a flush tank;

FIG. 10 is a detailed view of the flow modification device of the system of FIG. 9.

### DETAILED DESCRIPTION OF THE DRAWINGS

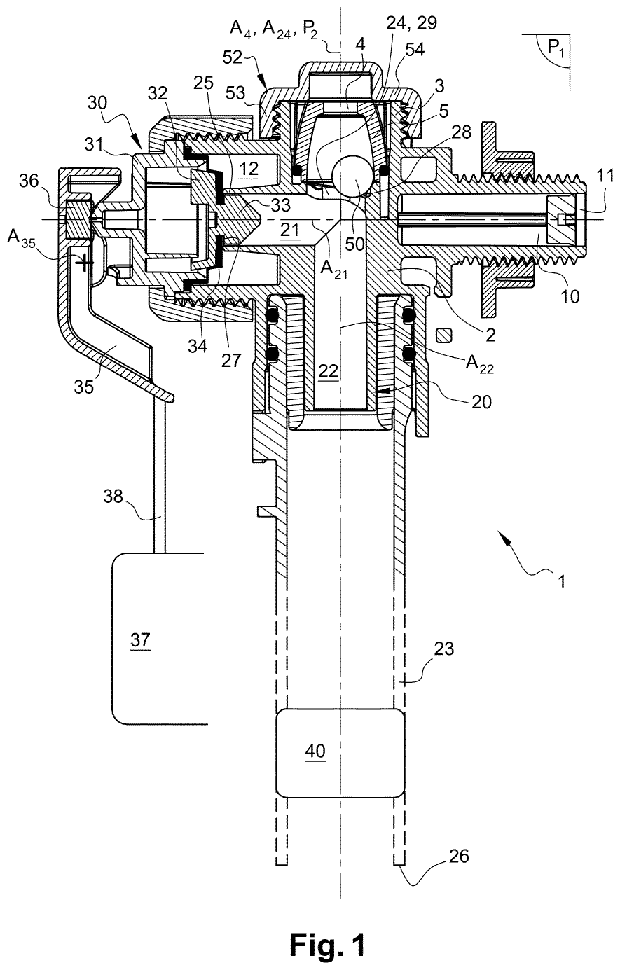

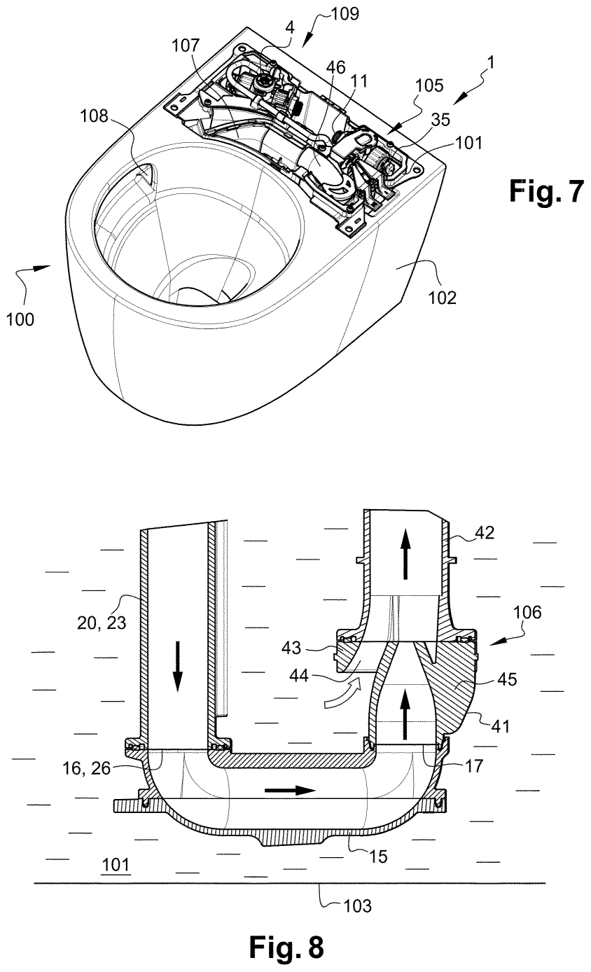

FIG. 1 represents a water feed system 1 according to one embodiment of the disclosure. Such a water feed system 1 makes it possible to feed water into a flush tank 101 belonging to a toilet 100, such as that illustrated as an example in FIG. 7.

The water feed system 1 is described below in its mounted position.

The water feed system 1 comprises a body 2. In the body 2 is provided a first pipe 10 which has an upstream end 11 configured to be connected to a water supply network. The first pipe 10 also has a downstream end which emerges into a chamber 12.

A second pipe 20 is provided at least partly in the body 2. The second pipe 20 has an upstream end 25 which is in fluid communication with the chamber 12, therefore with the first pipe 10, via an opening 27, and a downstream end 26 located lower than the upstream end 25.

According to a possible embodiment, the second pipe 20 includes a first substantially horizontal portion 21, which can be provided in the body 2, from the opening 27, extended by a second substantially vertical and descending portion 22, which can also be provided in the body 2. The second pipe 20 can further include a third vertical and descending portion 23, assembled in a sealed manner in the body 2, and extending the second portion 22 outside the body, up to the downstream end 26. The first portion 21 has an axis A 21 and the second portion 22 has an axis A 22.

The water feed system 1 further comprises a valve 30 mounted on the body 2. The valve 30 may comprise on the one hand a casing 31 defining an inner volume and having an opening facing the second pipe 20, and on the other hand a closing element 32 mounted in the opening of the casing 31.

The closing element 32 may include a head 33 which engages in the second pipe 20, the head 33 defining at its base an annular groove in which is mounted a flexible membrane 34 capable of being applied to the opening 27. In addition, the casing 31 includes a port 39 of small dimensions opposite the closing element 32.

According to the height of water in the tank 101, the valve 30 may be in a closed state in which it shuts off the opening 27 sealingly, thereby preventing the flow of water into the second pipe 20, or in an open state in which the opening 27 is free, allowing the flow of water into the second pipe 20.

More particularly, a lever 35 is mounted on the body 2 in a pivoting manner about an axis A 35 which is here substantially horizontal and parallel to the opening 27. The lever 35 is provided with a seal 36 located opposite the port 39 and is linked to a float 37, for example via a rod 38. Thus, the vertical movement of the float 37 causes the lever 35 to pivot and the seal 36 to move, shutting off or releasing the port 29. According to the pressure balancing, the membrane 34 is pressed sealingly against the opening 27, which corresponds to the closed state of the valve 30, or the membrane 34 is detached from the opening 27, which corresponds to the open state of the valve 30.

The body 2 includes in its upper part an air intake port 4. The air intake port 4 preferably extends in a substantially horizontal plane, and is preferably provided in the highest part of the body 2. For example, as illustrated in FIG. 1, the body 2 may include a cylindrical portion 3 with a vertical axis, projecting upwards, and located higher than the first and second pipes 10, 20. The cylindrical portion 3 is open at its upper end, and this opening, or a part of this opening, forms the air intake port 4. The air intake port 4 may have a substantially vertical axis A4. The axis A4 may be substantially coincident with the axis A22 of the second portion 22 of the second pipe 20.

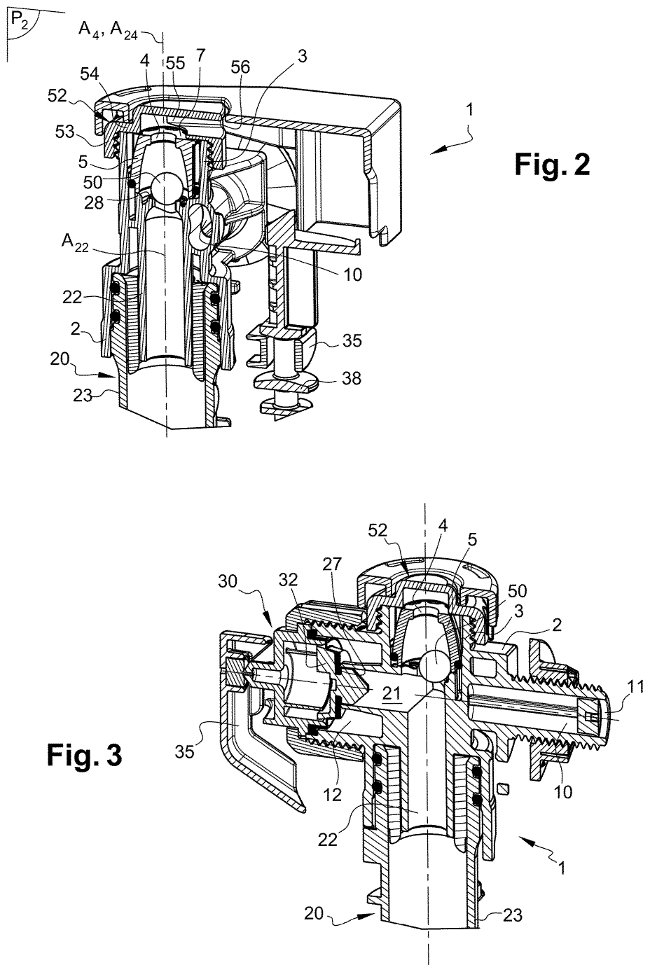

As illustrated in FIGS. 1 and 2, the plane P2 is defined as the vertical plane orthogonal to the first pipe 10 and containing the axis A4. The plane P1 is also defined as the vertical plane orthogonal to the plane P2 and containing the axis A4.

The second pipe 20 includes a lumen 24 which is located substantially vertically in line with the air intake port 4. In other words, the air intake port 4 is located substantially above the lumen 24. The lumen 24 may be provided in the first portion 21 of the second pipe 20, preferably in the vicinity of the junction between the first and second portions 21, 22 of the second pipe 20.

The lumen 24 has a peripheral edge 28 which defines a bearing surface. The lumen 24 may be oblong; thus, as seen in FIGS. 1 and 2, the width of the lumen is for example greater in the plane P 1 than in the plane P 2. The lumen 24 may have a substantially vertical axis A24. The axis A4 of the air intake port 4 and the axis A24 of the lumen 24 may be substantially the same, or be very close to each other.

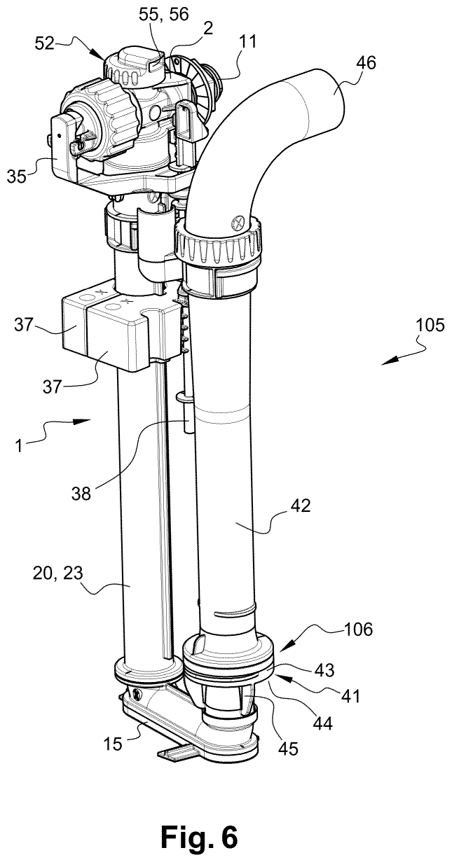

The water feed system 1 further comprises a flow modification device 40, represented schematically in FIG. 1. This device 40 is fastened to the second pipe 20 downstream of the lumen 24. Due to its structure, this device 40 creates a back pressure when water flows in the system 1 towards the tank 101. Preferably, the device 40 is located downstream of the body 2, for example in the third portion 23 of the second pipe 20 as illustrated in FIG. 1, or even downstream of the downstream end 26 of the second pipe 20, as will be described with reference to FIGS. 6 to 8.

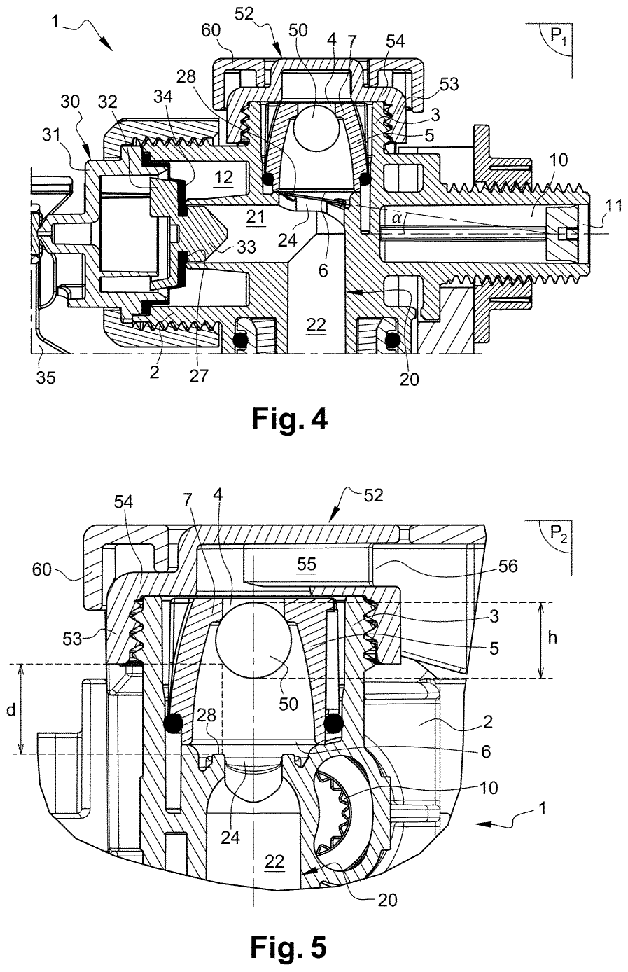

The water feed system 1 further comprises a shutter 50 whose function is to shut off the air intake port 4 when the valve 30 is open, to limit splashing. The shutter 50 is movable between:
a low position (FIGS. 1 to 3), in which it rests on the bearing surface 28, while providing in the lumen 24 a communication space 29 between the inside and the outside of the second pipe 20, the air intake port 4 then being clear;
and a high position (FIGS. 4 and 5), in which it shuts off the air intake port 4.

According to the disclosure, the shutter 50 has a density greater than 1.4. The density of a body is defined as the ratio between the mass of this body and that of the same volume of water or, in other words, as the ratio between the mass density of this body and the mass density of the water, as a reference. Thus, the shutter 50 cannot float on the water but on the contrary sinks in the water. Under these conditions, the movement of the shutter 50 from its low position to its high position does not result from floating on the water which flows in the water feed system 1, but from the thrust force due to the back pressure created by the flow modification device 40, that is to say the pressure which opposes the flow of the water.

The shutter 50 can be made of stainless steel, the density of which is in the range of 7 to 8, or of glass, the density of which is in the range of 2.4 to 2.8.

The shutter 50 can be a ball.

For example, a 1.5 to 2.5 g stainless steel ball can be used.

As seen in FIG. 4, it can be provided that the bearing surface defined by the lumen 24 extends substantially in a plane which is inclined relative to a horizontal plane, downstream, by an angle α in the range of 4 to 8°. With an oblong lumen 24 whose large dimension is oriented generally parallel to the axis A21 of the first portion 21 of the second pipe 20 (by means of the aforementioned inclination), a particularly interesting arrangement is obtained. Indeed, in this way, in the low position, due to gravity, the shutter 50 is located reproducibly at the downstream end of the lumen 24. In addition, the upstream part of the lumen 24 is free, allowing more efficient evacuation of the air.

In the example illustrated in FIG. 1, the shutter 50 is located in the cylindrical portion 3 of the body 2. According to a possible embodiment, a housing 5 is provided in said cylindrical portion 3 to receive the shutter 50. The housing 5 is sealingly mounted inside the cylindrical portion 3 and extends over substantially the entire height of the cylindrical portion 3.

The housing 5 has the shape of a bell converging upwards. It has a lower opening 6 located in the vicinity of the lumen 24 provided in the second pipe 20 and, at its upper part, an inner collar 7 defining a substantially round central opening with a vertical axis which forms the air intake port 4. Thus, the air intake port 4 is provided in a substantially horizontal wall.

The operation of the water feed system 1 is as follows.

When the tank 101 is filled, the float 37 is in the high position and the water feed system 1 is then in an inactive state where the flap 32 is in the closed position and the shutter 50 in the low position (FIGS. 1 to 3).

Starting from this inactive state of the system 1, when the water level in the tank 101 drops, typically after the flush system has been actuated, the float 37 descends, causing the lever 35 to pivot and the flap 32 to open. Water from the supply network can then flow into the second pipe 20. This flow in itself would not allow the shutter 50 to be moved to its upper position, since the shutter 50 is too dense to be able to float. In contrast, the flow of water into the flow modification device 40 creates a back pressure. This increase in pressure downstream of the flow modification device 40 exerts a sufficient force on the shutter 50 to cause it to move to its upper position (FIGS. 4 and 5).

Since the rise of the shutter 50 does not occur immediately, due to the flotation phenomenon, but occurs with an offset while the back pressure is created, the air present in the body 2, and in particular in the housing 5, can be evacuated through the air intake port 4 which is not immediately shut off.

The convergent shape of the housing 5 makes it possible to guide the movement of the shutter 50. This makes it possible to avoid jamming of the shutter 50, in particular when the latter is not perfectly aligned vertically with the air intake port 4, as can be seen for example in FIG. 1. The convergent shape of the housing 5 also makes it possible to channel the air towards the air intake port 4.

In order to further increase the time required to shut off the air intake port 4, to allow more air to be evacuated, it may be provided that the distance d to be traveled by the shutter 50 between the low position and the high position is relatively large. Thus, this distance d may be greater than half the height h of the shutter 50 (that is to say the diameter of the shutter when the latter is a ball), and preferably greater than this height h. For example, the distance d may be in the range of 1.25×h. According to one embodiment, for example, the distance d may be comprised between 10 and 15 mm.

Since the air intake port 4 is not immediately shut off when water begins to flow into the second pipe 20, droplets are likely to pass through this port, which is not desirable. To limit splashing, a cap 52 may be provided which is mounted on the body 2 above the air intake port 4. The cap 52 may include a skirt 53 which is for example screwed or clipped onto the cylindrical portion 3 of the body 2, a transverse wall 54, and a channel 55 which is located above the transverse wall 54 and which extends for example substantially parallel to the latter. The channel 55 has a hole located opposite the air intake port 4 and emerges outside the body 2, via a hole 56. Thus, drops projected from inside the body via the air intake port 4 can enter the channel 55, while being projected against its upper wall, then always fall back into the channel 55 where they are guided to the hole 56, to finally fall back into the tank 101 in which the water feed system 1 is mounted.

Of course, air can also enter via the channel 55 to the air intake port 4.

In addition, a deflector 60 (see FIGS. 4 and 5) may be mounted above the cap 52, so that splashing is as little visible and as little audible as possible.

Such a water feed system 1 is intended to be part of a toilet 100 further comprising a flush tank 101 and a bowl 102. Said system 1 is generally housed in the tank 101. The water feed system 1 can be used in different ways as will be seen below.

We refer to FIGS. 6 to 8 which illustrate a first embodiment.

In this case, the flow modification device 40 comprises a tip 41 which is fastened to the downstream end 26 of the second pipe 20. More specifically, the downstream end 26 of the second pipe 20 may be located near the bottom wall 103 of the tank 101, as schematically illustrated in FIG. 8, and the tip 41 may be fastened to the downstream end 26 of the second pipe 20 via an intermediate pipe 15. The intermediate pipe 15 may have an angled shape allowing the flow of water to change from a substantially vertical descending direction to a substantially vertical ascending direction. Thus, the tip 41 is crossed by an ascending water stream. The inlet 16 of the intermediate pipe 15, fastened directly to the downstream end 26 of the second pipe 20, and the outlet 17 of the intermediate pipe 15 may be located substantially at the same height.

The tip 41 has a convergent section. It may include a substantially cylindrical upstream section extended by a substantially truncated downstream section.

Furthermore, a vertically ascending ejection tube 42 is mounted on the tip 41. For this purpose, the tip 41 may comprise a collar 43 at its downstream end on which the upstream end of the ejection tube 42 is fastened, opposite the tip 41. The collar 43 is provided with at least one port 44 and, preferably, reinforcing fins 45. In addition, a discharge tube 46 is mounted at the downstream end of the ejection tube 42.

When the flap 32 is open and the water circulates in the second pipe 20, the narrowing formed by the tip 41 causes an increase in the flow rate of the water and a decrease in the pressure, therefore a suction of the water contained in the tank 101 through the port(s) 44, into the ejection tube 42. As illustrated in FIG. 8, the tip 41 and the upstream part of the ejection tube 42 thus form a device 106 for sucking by Venturi effect.

The discharge tube 46 is configured to direct the water towards the bowl 102. For this purpose, the discharge tube 46 can be bent and its downstream end can emerge into or opposite a space 107 of the toilet communicating with an overflow 108 emerging into the upper part of the bowl 102.

The water feed system 1, the ejection tube 42 and the discharge tube 46 thus form a flush system 105.

The operation of such a flush system 105, based on suction by Venturi effect, does not involve gravity. Therefore, the flush tank 101 does not need to be positioned high up. As seen in FIG. 7, the tank 101 can be located substantially at the same height as the bowl 102, which makes it possible to obtain very compact toilets 100.

Furthermore, the toilet 100 comprises a system 109 for filling the flush tank 101 which is separate from the flush system 105.

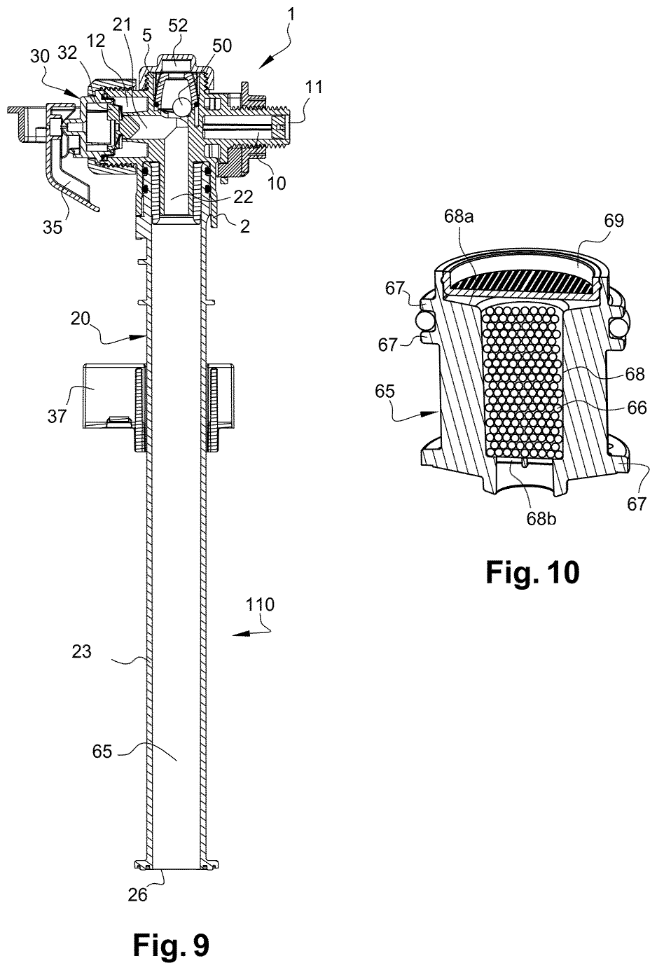

We now refer to FIGS. 9 and 10 which illustrate a second embodiment.

In this case, the flow modification device 40 comprises a sleeve 65 mounted inside the second pipe 20, preferably in the third portion 23, as shown schematically in FIG. 9. The sleeve 65 contains a set of balls 66 between which the water can flow, and forms a silencer allowing the decrease of the noise generated by the flow. The sleeve 65 can be filled with balls 66 over at least 80% of its height. For example, the balls 66 can have a diameter in the range of 1 mm.

The passage of water between the balls 66 slows the flow and therefore creates a back pressure.

As seen in FIG. 10, the sleeve 65 may have a diameter smaller than that of the portion of the second pipe 20 in which it is inserted, and be provided with outer peripheral lips 67 ensuring maintenance and sealing relative to the inner face of the second pipe. The sleeve 65 may have a main part 68, containing the balls 66 whose inlet 68a, of larger diameter, is equipped with a filtration element 69, and whose outlet 68b, of smaller diameter, forms a narrowing of section.

Such a water feed system 1 forms a system 110 for filling a flush tank 101, intended to be placed in such a tank 101.

Thus, the disclosure provides a decisive improvement to the systems for feeding water into a flush tank, by allowing a significant decrease in the noise generated by the entry of water into the tank, particularly when this system is provided with a flow modification device which creates a back pressure during operation. Thanks to the possible presence of a cap, this sound advantage is not accompanied by the appearance of undesirable splashing. Furthermore, such a system can find different applications, in particular as a flush system implementing the Venturi effect, or as a flush tank filling system.

It goes without saying that the disclosure is not limited to the embodiments described above as examples but that it comprises all technical equivalents and variants of the means described as well as their combinations.

1. A system for feeding water into a flush tank, comprising, in the mounted position:
a body including in its upper part an air intake port;
a first pipe provided in the body, configured to be connected, at its upstream end, to a water supply network;
a second pipe provided at least partly in the body, having an upstream end in fluid communication with the first pipe via an opening, and a downstream end located lower than the upstream end, the second pipe including a lumen located substantially vertically in line with the air intake port, the peripheral edge of the lumen defining a bearing surface;
a valve which is mounted on the body and which, according to the height of water in the tank, can be in a closed state in which the valve shuts off said opening sealingly, or in an open state in which the opening is released;
a shutter movable between:
a low position, in which the shutter rests on the bearing surface while providing in the lumen a communication space between the inside and the outside of the second pipe, the air intake port being clear;
and a high position, in which the shutter shuts off the air intake port;
wherein the water feed system further comprises a flow modification device which is fastened to the second pipe downstream of the lumen and which creates a back pressure when water flows through the system towards the tank, and in that the shutter has a density greater than 1.4, thus preventing the shutter it from floating, so that, starting from an inactive state of the system where the flap is in the closed position and the shutter is in the lower position, the opening of the valve and the resulting flow of water into the second pipe causes the shutter to move to its upper position under the effect of the back pressure created by the flow modification device.

2. The water feed system according to claim 1, wherein the shutter is made of a material belonging to the group consisting of: stainless steel, glass, aluminum, polyoxymethylene (POM), and filled plastic materials.

3. The water feed system according to claim 1, wherein the shutter is a ball.

4. The water feed system according to claim 3, wherein the lumen provided in the second pipe is oblong or substantially oval.

5. The water feed system according to claim 1, wherein the distance (d) traveled by the shutter between the low position and the high position is greater than half the height (h) of the shutter, preferably greater than the height (h) of the shutter.

6. The water feed system according to claim 1, wherein the shutter is located in a housing provided in the body, said housing having the shape of a bell converging upwards, and having a lower opening located in the vicinity of the lumen provided in the second pipe and an upper opening located in the vicinity of the air intake port or forming the latter.

7. The water feed system according to claim 1, wherein the second pipe includes a first substantially horizontal portion in which the lumen is provided, extended by a second substantially vertical and descending portion, the lumen preferably being located in the vicinity of the junction between the first and second portions.

8. The water feed system according to claim 4, wherein the bearing surface defined by the lumen extends substantially in a plane which is inclined relative to a horizontal plane, downstream, by an angle (α) in the range of 4 to 8°, and in that the lumen has a large dimension oriented generally parallel to the axis of the first portion of the second pipe.

9. The water feed system according to claim 1, further comprising a cap which is mounted on the body above the air intake port, and which includes a channel having a hole located opposite the air intake port and emerging outside the body, so that drops projected from the inside of the body via the air intake port can enter the channel and be guided therein until they fall back into the tank, in the mounted position of the system.

10. The water feed system according to claim 1, wherein the flow modification device comprises a tip fastened to the downstream end of the second pipe, the tip having a convergent section and being configured to form part of a device for sucking by Venturi effect.

11. The water feed system according to claim 1, wherein the flow modification device comprises a sleeve mounted inside the second pipe, the sleeve containing a set of balls between which the water can flow, and forming a silencer allowing the decrease of the noise generated by the flow.

12. A toilet including a bowl a flush tank and a system for feeding water into the tank according to claim 1.

13. The toilet according to claim 12, comprising a flush system which includes:
a water feed system comprising a cap which is mounted on the body above the air intake port, and which includes a channel having a hole located opposite the air intake port and emerging outside the body, so that drops projected from the inside of the body via the air intake port can enter the channel and be guided therein until they fall back into the tank, in the mounted position of the system;
an ascending vertical ejection tube mounted on the tip, the upstream end of the ejection tube being placed opposite the downstream end of the tip, at least one port being provided between the tip and the ejection tube to allow the suction of the water contained in the tank by Venturi effect;
a discharge tube mounted at the downstream end of the ejection tube, for directing water towards the bowl.

14. The toilet according to claim 13, wherein the flush tank is located substantially at the same height as the bowl, and in that the toilet further comprises a system for filling the flush tank which is separate from the flush system

15. The toilet according to claim 12, wherein the water feed system comprises a flow modification device including a sleeve mounted inside the second pipe, the sleeve containing a set of balls between which the water can flow, and forming a silencer allowing the decrease of the noise generated by the flow, said water feed system forming a system for filling the flush tank.
